(19) United States
(12) Patent Application Publication
(10) Pub. No.: US 2026/0260655 A1
(43) Pub. Date: Sep. 3, 2026

(54) MULTILINGUAL SPEECH RECOGNITION MODELS FOR SPEECH PROCESSING SYSTEMS AND APPLICATIONS

(71) Applicant: NVIDIA Corporation, Santa Clara, CA (US)

(72) Inventors: Enas Abdullah M Albasiri, Brooklyn, NY (US); Myungjong Kim, Milpitas, CA (US); Jinhan Wang, Santa Clara, CA (US); Oluwatobi Olabiyi, San Francisco, CA (US)

(21) Appl. No.: 19/066,468

(22) Filed: Feb. 28, 2025

(51) Int. Cl. G10L 15/26; G10L 15/00

(52) U.S. Cl. CPC G10L 15/26; G10L 15/005

(57) ABSTRACT

In various examples, multilingual speech processing models for speech processing systems and applications is described here. Systems and methods described herein may use an end-to-end model that is capable of performing both ASR processing and translation processing to generate text in various languages. For instance, a user may provide at least audio data representing speech along with an indication of a target language for translating the speech. The model may then generate one or more audio representations associated with the speech along with one or more language representations associated with the target language. Additionally, the model may combine the audio representation(s) with the language representation(s)-such as by performing concatenation, masking, fusion, adding, and/or the like-to generate one or more combined representations. The model may then process the combined representation(s) to generate text corresponding to the speech and in the target language.

### BACKGROUND

Automatic speech recognition (ASR) models are used to process speech from users in order to convert the speech to text. In some instance, an ASR model may also be capable performing language translation in one direction-such as from an initial language of speech to another language for which the ASR model was trained- or additional machine learning models may be used to translate text from an ASR model to target languages desired by users. For example, if a user wants to translate speech from English to French, then a system may use an ASR model that is specifically trained to perform such processing of converting the speech in English to generate corresponding text in French. Alternatively, a system may use an ASR model that initially converts the speech to text in English and then use an additional model that translates the text to French. As such, conventional systems that perform ASR processing either require specially trained models that translate in one direction or multiple models to translate different languages (e.g., a separate model for each language to language conversion).

### SUMMARY

Embodiments of the present disclosure relate to multilingual speech processing models for speech processing systems and applications. Systems and methods described herein may use an end-to-end machine learning model that is capable of performing both ASR processing and translation processing to generate text in various languages. For instance, a user or system (e.g., automatically, based on known parameters of a task, operation, or system) may provide at least audio data representing speech along with an indication of a target language for translating the speech. The machine learning model may then generate one or more audio representations (e.g., one or more vectors, embeddings, tensors, kernels, features, etc.) associated with the speech along with one or more language representations (e.g., one or more vectors, embeddings, tensors, kernels, features, etc.) associated with the target language. Additionally, the machine learning model may combine the audio representation(s) with the language representation(s)-such as by performing concatenation, masking, fusion, adding, and/or the like-to generate one or more combined representations. The machine learning model may then process the combined representation(s)-such as by using one or more decoders-to generate text corresponding to the speech and in the target language.

In contrast to conventional systems, the systems of the present disclosure, in some embodiments, use the end-to-end machine learning model that is capable to performing both ASR processing and translation processing to generate text in various language. More specifically, in contrast to the conventional systems that use specially trained ASR models that translate speech in one direction, the systems of the present disclosure are able to use the end-to-end machine learning model to translate speech using multiple direction (e.g., into various languages). Additionally, in contrast to the conventional systems that use different models to perform ASR processing and language translation, the systems of the present disclosure are able to perform both the speech processing and the language translation using the single machine learning model. In either instance, the systems of the present disclosure may reduce the amount of computing resources (e.g., models), storage (e.g., only storing one model, rather than separate models for each language to language translation), latency, and/or training associated with processing speech. In addition, by training a single model for any number of languages, the model may learn from nuances or styles of similar languages, thereby allowing the single model to perform better on a translation than separate models trained specifically for one language to one language translation.

### BRIEF DESCRIPTION OF THE DRAWINGS

The present systems and methods for multilingual speech recognition models for speech processing systems and applications are described in detail below with reference to the attached drawing figures, wherein:

FIG. 1 illustrates an example data flow diagram for a process for using one or more multilingual machine learning models to translate speech into different textual languages, in accordance with some embodiments of the present disclosure;

FIG. 2 illustrates an example of generating an audio representation and a language representation, in accordance with some embodiments of the present disclosure;

FIG. 3 illustrates a first technique of combining an audio representation with a language representation that uses concatenation or other vector/tensor combination techniques, in accordance with some embodiments of the present disclosure;

FIG. 4 illustrates a second technique of combining an audio representation with a language representation that uses a sinusoidal transformation, in accordance with some embodiments of the present disclosure;

FIG. 5 illustrates an example of using one or more machine learning models to perform ASR processing and translation processing, in accordance with some embodiments of the present disclosure;

FIG. 6 illustrates an example of a process for training one or more machine learning models to perform ASR processing and translation processing, in accordance with some embodiments of the present disclosure;

FIG. 7 illustrates an example of one or more systems that may perform one or more of the processes described herein to translate speech, in accordance with some embodiments of the present disclosure;

FIG. 8 illustrates a flow diagram showing a method for using a multilingual model to translate speech into text, in accordance with some embodiments of the present disclosure;

FIG. 9 illustrates a flow diagram showing a method for translating speech to text that is in a target language, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed for multilingual speech recognition models for speech processing systems and applications. For instance, a system(s) may receive audio data representing speech along with input data indicating a target language for generating text corresponding to the speech. In some examples, the target language may include a same language as the speech while, in other examples, the target language may include a different language as compared to the speech. Additionally, as described herein, a language may include, but is not limited to, English, Spanish, French, Arabic, German, Chinese, Japanese, Dutch, and/or any other language. The system(s) may then use an end-to-end machine learning model (the “model”) that is configured to perform both ASR processing and translation processing to process the audio data and generate text corresponding to the speech and in the target language.

For instance, the model may process the audio data-such as by using one or more encoders (and/or any other type of processing component)-to generate one or more audio representations associated with the audio information. As described herein, an audio representation may include, but is not limited to, one or more vectors, one or more embeddings, one or more tensors, one or more kernels, one or more features, and/or any other type of representation of the audio data. The model may also process the input data-such as by using one or more encoders (and/or any other type of processing component)-to generate one or more language representations associated with the target language information. As described herein, a language representation may include, but is not limited to, one or more vectors, one or more embeddings, one or more tensors, one or more kernels, one or more features, and/or any other type of representation. In some examples, the language representation(s) may represent a similar amount of time as the audio representation(s). For instance, the language representation(s) may represent a time period that is associated with the audio data.

As described herein, in some examples, the language representation(s) (e.g., a vector) may be generated to include dimensions associated with a number of languages for which the model is able to translate. For example, if the model is configured to translate 128 languages, then the language representation(s) may include 128 dimensions. Additionally, in some examples, one-hot encoding may be used for language identification, such that one or more elements of the language representation(s) that are associated with the target language may include a first value (e.g., 1) while one or more other elements of the language representation(s) that are associated with one or more other languages include a second value (e.g., 0). The model may then combine the audio representation(s) with the language representation(s)—such as by using by using one or more projection layers (and/or any other type of layer)—to generate one or more combined representations. As described herein, a combined representation may include, but is not limited to, one or more vectors, one or more embeddings, one or more tensors, one or more kernels, one or more features, and/or any other type of representation.

The model may use one or more techniques to combine the audio representation(s) with the language representation(s). For instance, in some examples, the model may concatenate the language representation(s) with the audio representation(s) to generate one or more concatenated representations. In such examples, the model may then further process the concatenated representation(s) to reduce the dimensions back to the original audio representation(s) while integrating the language information with the audio information. Additionally, or alternatively, in some examples, the model may generate one or more additional language representations using the language representation(s) and a sinusoidal kernel (e.g., a fixed kernel matrix) that encodes different frequencies associated with the target language. For instance, the additional language representation(s) may be generated by multiplying the language representation(s) by the sinusoidal kernel to project the language information into the same dimensionality as the audio representation(s). The model may then add the additional language representation(s) to the audio representation(s), such as by masking the audio representation(s) with the additional language representation(s). While these are just two example techniques for how the representations may be combined, in other examples, the representations may be combined using any other technique.

The model may then process the combined representation(s)-such as by using one or more decoders (and/or any other type of processing component)-to generate output data associated with text corresponding to the speech and in the target language. In some examples, the output data may represent tokens corresponding to the text, where the model and/or one or more additional processing components then process the tokens to generate the text associated with the speech. However, in some examples, the output data may represent the actual text corresponding to the speech, such as a transcript of the speech. In either of the examples, the system(s) may then perform one or more tasks using the text, such as providing the text to the user, further processing the text using additional processing components, and/or any other task.

While these examples describe processing the audio data to generate text in a single target language, in other examples, similar processes may be used to process one or more instances of audio data to generate text in multiple target languages. For instance, for another target language, the model may generate one or more additional language representations that are associated with the other target language. The model may then process audio data-such as by using the additional language representation(s) and one or more audio representations associated with the audio data-using one or more of the processes described herein to generate text corresponding to speech from the audio data and in the other language. In other words, the system(s) may use the end-to-end model to process audio data representing speech in different languages to generate translated text in multiple languages.

In some examples, the system(s) (and/or another system(s)) may train the model to perform one or more of the processes described herein. For instance, the system(s) may train the model using training input data-such as audio data representing speech and a manifest of target languages associated with the speech-along with ground truth data representing text associated with the speech and in the target languages. The system(s) may then process the training input data, using of the processes described herein, to generate output data representing text. Additionally, the system(s) may determine one or more losses based at least on comparing the output text to the ground truth text and update the model based at least on the loss(es). For example, the system(s) may update one or more weights and/or parameters of the encoder(s), the projection layer(s), the decoder(s), and/or the like based at least on the loss(es).

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs-such as, without limitation, REST APIs. For example, the talking kiosk may deploy the machine learning model(s) described herein to perform translation for users of the kiosk.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. For example, the machine learning model(s) described herein may be used to perform translation for users who speak any number of languages to any number of other languages. As such, the game and/or other users are able to understand and communicate across languages.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. For example, the machine learning model(s) described herein may be used to perform translation for users who speak any number of languages to any number of other languages. As such, the video conferencing application and/or other users are able to understand and communicate across languages.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). For example, the machine learning model(s) described herein may be used to perform translation for the robot to communicate with persons/other robots in an environment across any number of languages to any number of other languages. As such, the robot is able to understand and communicate across languages.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. For example, the machine learning model(s) described herein may be used to perform translation for users within a vehicle to translate any number of languages to any number of other languages. As such, the users and the vehicle are able to understand and communicate across languages.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices-such as GPUs-to provide better performance with lower memory utilization in both training and inference. When the TE is combined with other technologies, such as high-speed interconnects between nodes (e.g., using switches-such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

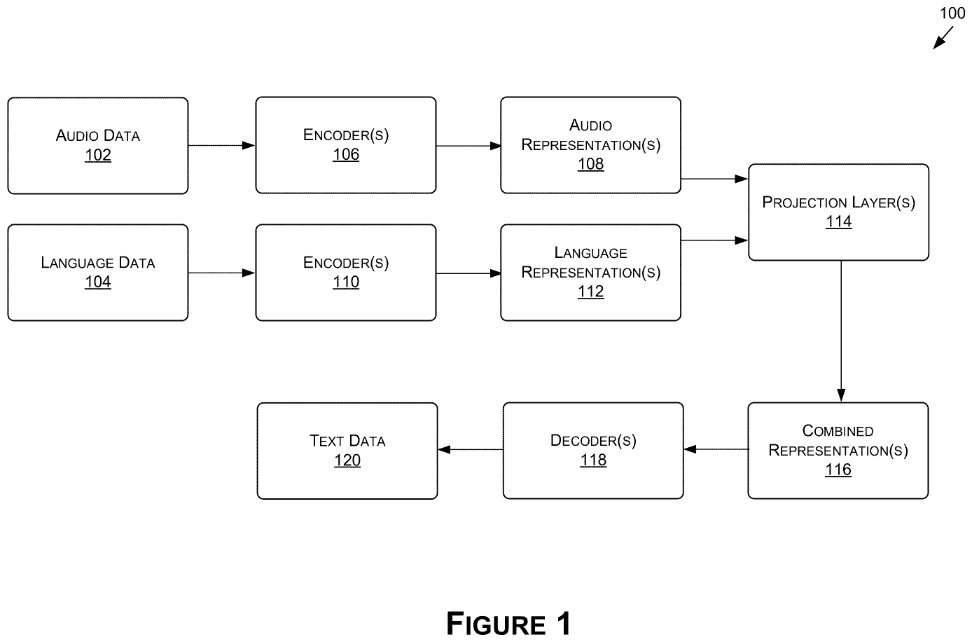

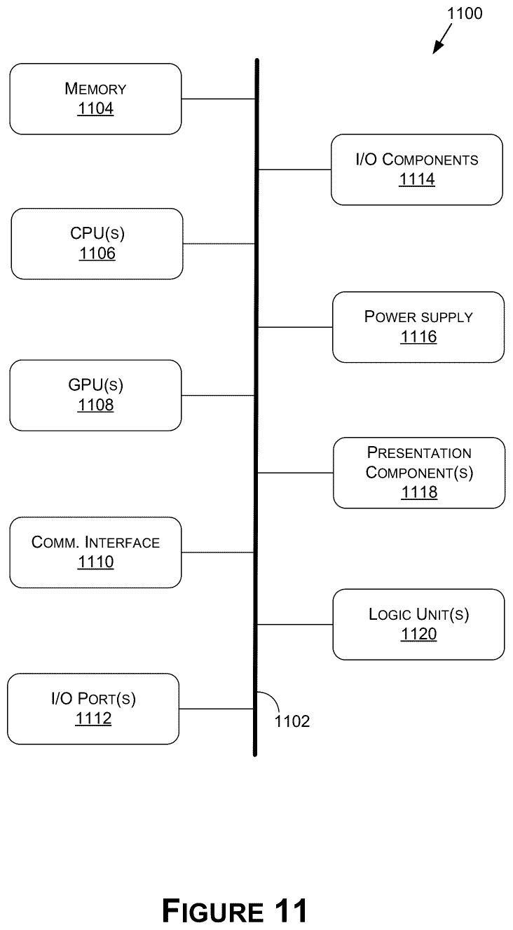

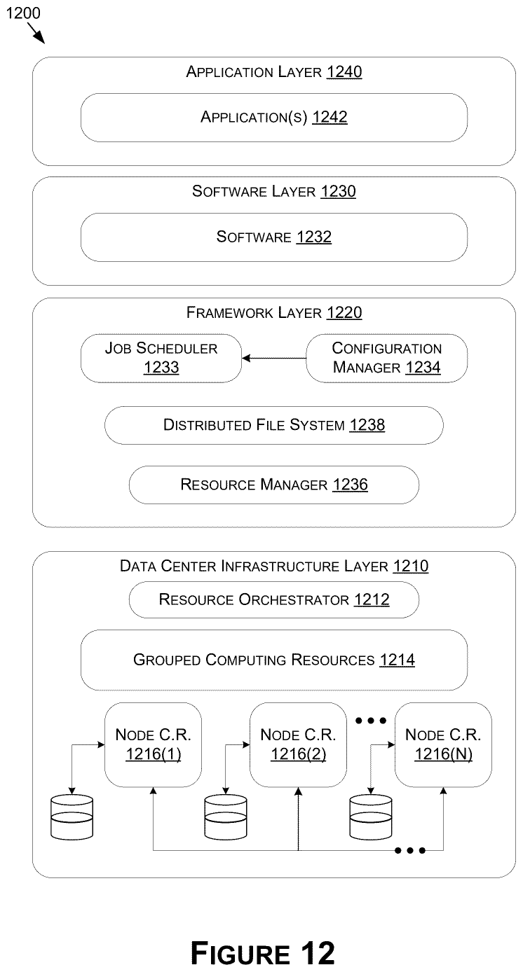

With reference to FIG. 1, FIG. 1 illustrates an example data flow diagram for a process 100 for using one or more multilingual machine learning models to translate speech into different textual languages, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1100 of FIG. 11 and/or example data center 1200 of FIG. 12.

The process 100 may include receiving audio data 102 representing at least speech from a user along with language data 104 representing a target language for generating text corresponding to the speech. In some examples, the target language may include a same language as the speech while, in other examples, the target language may include a different language as compared to the speech. Additionally, as described herein, the language data 104 may include and/or be associated with input data indicating the target language, selection data representing a selection of the target language, history data representing a historical target language that is used, and/or any other type of data. Furthermore, a language may include, but is not limited to, English, Spanish, French, Arabic, German, Chinese, Japanese, Dutch, and/or any other type of language.

The process 100 may then include using one or more encoders 106 of the machine learning model(s) to process the audio data 102 and, based at least on the processing, generate one or more audio representations 108 corresponding to the audio data 102. As described herein, an encoder 106 may include any type of encoder—such as an audio encoder, a FastConformer encoder, a one-hot encoder, a Variational Autoencoder, a Recurrent Neural Network encoder, and/or the like—that is configured to perform one or more of the processes described herein. Additionally, an audio representation 108 may include, but is not limited to, one or more vectors, one or more embeddings, one or more tensors, one or more kernels, one or more features, and/or any other type of representation of the audio data. For example, the audio representation(s) 108 may include one or more vectors that capture features of one or more portions of the speech represented by the audio data, such as in a multi-dimensional embedding space.

The process 100 may also include using one or more encoders 110 of the machine learning model(s) to process the language data 104 and, based at least on the processing, generate one or more language representations 112 corresponding to the target language indicated by the language data 104. As described herein, an encoder 110 may include any type of encoder—such as one-hot encoder, an ordinal encoder, a binary encoder, a label encoder, a frequency encoder, and/or the like—that is configured to perform one or more of the processes described herein. Additionally, an audio representation 108 may include, but is not limited to, one or more vectors, one or more embeddings, one or more tensors, one or more kernels, one or more features, and/or any other type of representation of the audio data. For instance, in some examples, the language representation(s) 112 may include one or more vectors, where an individual vector includes dimensions that correspond to a number of languages for which the machine learning model(s) is configured to translate. In such examples, one or more elements of the vector(s) that are associated with the target language may include a first value, such as one (and/or any other value), while one or more elements of the vector(s) that are associated with one or more other languages may include a second value, such as zero (and/or any other value).

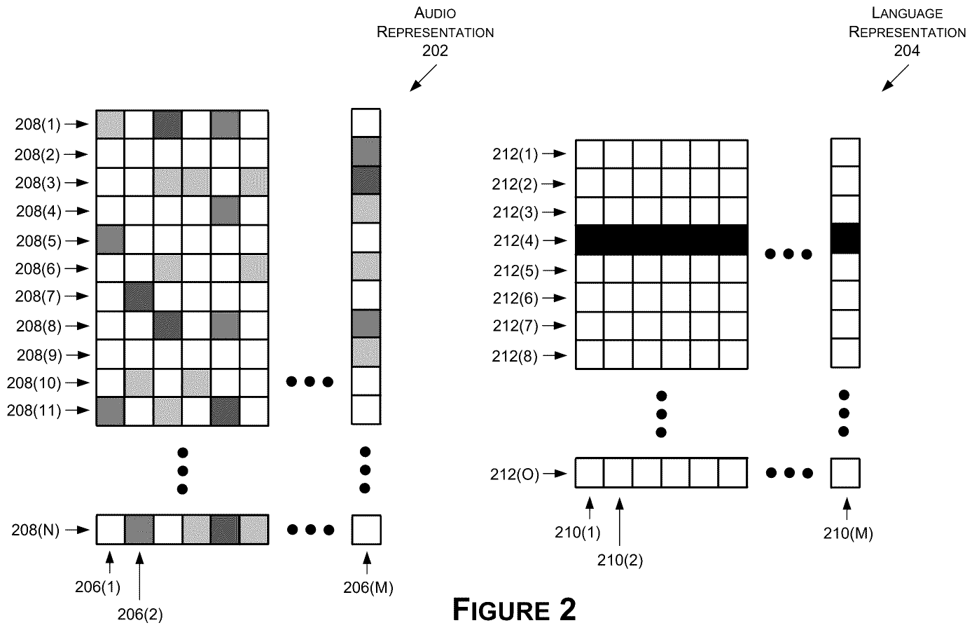

For instance, FIG. 2 illustrates an example of generating an audio representation 202 (which may include, and/or be similar to, an audio representation 108) and a language representation 204 (which may include, and/or be similar to, a language representation 112), in accordance with some embodiments of the present disclosure. As shown, the audio representation 202 may include a number of vectors 206(1)-(M) (also referred to singularly as “vector 206” or in plural as “vectors 206”) (where only three are labeled for clarity reasons) that are appended to one another. For example, the individual vectors 206 may be associated with different time instances. Additionally, the vectors 206 may include dimensions 208(1)-(N) (also referred to singularly as “dimension 208” or in plural as “dimensions 208”). As described herein, the vectors 206 may include any number of dimensions 208, such as 512 dimensions (and/or any other number of dimensions). In some examples, the audio representation 202 may correspond to an acoustic embedding.

As further illustrated in FIG. 2, the language representation 204 may include a number of vectors 210(1)-(M) (also referred to singularly as “vector 210” or in plural as “vectors 210”) (wherein only three are labeled for clarity reasons) that are appended to one another. For example, individual vectors 210 may again be associated with the different time instances. Additionally, the vectors 210 may include dimensions 212(1)-(O) (also referred to singularly as “dimension 212” or in plural as “dimensions 212”). As described herein, in some examples, the dimensions 212 may be based on the number of languages that the machine learning model(s) is configured to translate and/or may be configured to translate in the future. For example, an individual dimension 212 may be associated with a respective language, such that there will be 128 dimensions if the machine learning model(s) is configured to translate 128 languages (and/or any other number of dimensions for any number of languages).

In the example of FIG. 2, different shadings within the elements of the audio representation 202 and/or the language representation 204 may represent different values for elements. For instance, and with regard to the language representation 204, the elements associated with the fourth dimension 214(4) may include a first value, such as one (and/or any other value), while the elements associated with the other dimensions 214(1)-(3) and 214(5)-(O) include a second value, such as zero (and/or any other value). This is because, in the example of FIG. 2, the user may have selected a target language that is represented by the fourth dimension 212(4) for translating speech associated with the audio representation 202. While the example of FIG. 2 illustrates only selecting a single target language for translation, in other examples, a user may select any number of target languages.

Referring back to the example of FIG. 1, the process 100 may include using one or more projection layers 114 of the machine learning model(s) to process the audio representation(s) 108 and the language representation(s) 112 and, based at least on the processing, generate one or more combined representations 116. While the example of FIG. 1 illustrates using the projection layer(s) 114 to generate the combined representation(s) 116, in other examples, any other type of layers of the machine learning model(s) may be configured to perform similar processes described herein to generate the combined representation(s) 116. Additionally, a combined representation 116 may include, but is not limited to, one or more vectors, one or more embeddings, one or more tensors, one or more kernels, one or more features, and/or any other type of representation.

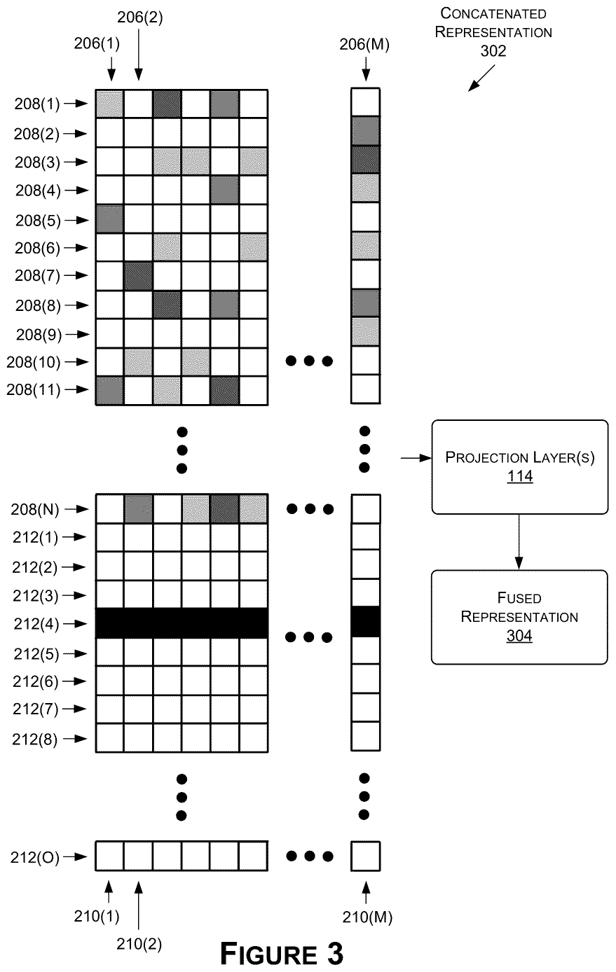

As described herein, the projection layer(s) 114 may use one or more techniques to generate the combined representation(s) 116. For instance, FIG. 3 illustrates a first technique of combining the audio representation 202 with the language representation 204 that uses concatenation, in accordance with some embodiments of the present disclosure. As shown, the projection layer(s) 114 may concatenate the audio representation 202 with the language representation 204 to generate a concatenated representation 302. Additionally, the example of FIG. 3 illustrates the projection layer(s) 114 performing the concatenation by stacking the audio representation 202 above the language representation 204 along the features dimensions. However, in other examples, the projection layer(s) 114 may perform the concatenation using any other technique, such as stacking the language representation 204 above the audio representation 202.

In some examples, and as further illustrated in FIG. 3, the projection layer(s) 114 may further process the concatenated representation 302 to generate a fused representation 304 that includes less dimensions than the concatenated representation 302. For example, the dimensions of the fused representation 304 may correspond to (e.g., be the same as) the dimensions of the audio representation 202. When performing such a process, the projection layer(s) 114 may use learned relationships between language information and audio to generate the fused representation 304. As such, in some examples, the concatenated representation 302 may include a combined representation 116 while, in other examples, the fused representation 304 may include a combined representation 116.

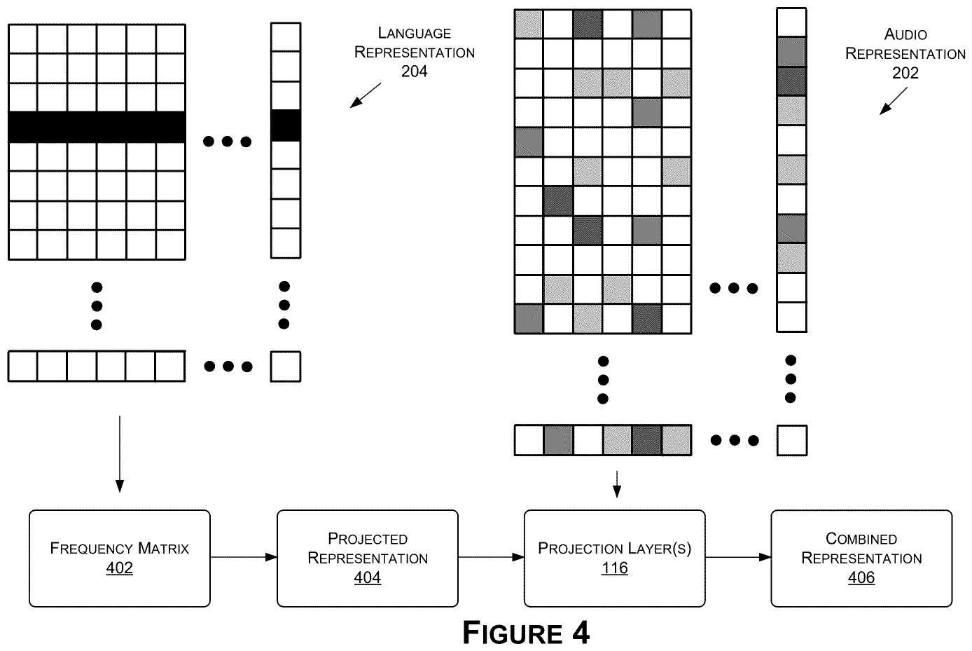

Next, FIG. 4 illustrates a second technique of combining the audio representation 202 with the language representation 204 that uses a sinusoidal transformation, in accordance with some embodiments of the present disclosure. As shown, the language representation 204 may be processed with respect to a frequency matrix 402 to generate a projected representation 404. As described herein, the projected representation 404 may include, but is not limited to, one or more vectors, one or more embeddings, one or more tensors, one or more kernels, one or more features, and/or any other type of representation of the audio data. Additionally, one or more elements of the frequency matrix 402 (e.g., each element of the frequency matrix 402) may be encoded at one or more different frequencies in order to create a unique patter for one or more (e.g., each) language dimension. For instance, different frequency matrices may be generated for the different target languages, where an individual frequency matrix includes a unique pattern of encoded frequencies associated with an individual target language.

In some examples, the language representation 204 may be multiplied by the frequency matrix 402 that includes specific dimensions such that the projected representation 404 represents the language information in the same dimensionality as the audio representation 202. This way, and as further illustrated by the example of FIG. 4, the projection layer(s) 114 may add the features of the projected representation 404 to the features of the audio representation 202 such as by masking the features of the audio representation 202 (and/or using any other technique) -to generate a combined representation 406 (which may include a combined representation 116). By performing such a process, the projection layer(s) 114 may preserve the original features of the audio representation 202 through the combination of the features.

Referring back to the example of FIG. 1, the process 100 may include using one or more decoders 118 of the machine learning model(s) to process the combined representation(s) 116 and, based at least on the processing, generate text data 120 representing text corresponding to the speech and in the target language. As described herein, a decoder 118 may include any type of decoder—such as a Recurrent Neural Network Transducer (RNNT) decoder, a Connectionist Temporal Classification (CTC) decoder, a Token-and-Duration Transducer (TCT), and/or the like—that is configured to perform one or more of the processes described herein. In some examples, the text data 120 may represent a final text version of the speech, such as transcribed text corresponding to the speech. However, in other examples, the text data 120 may represent a tokenized text version of the speech. In such examples, the machine learning model(s) and/or one or more other processing components may process the text data 120 to generate the final text version of the speech.

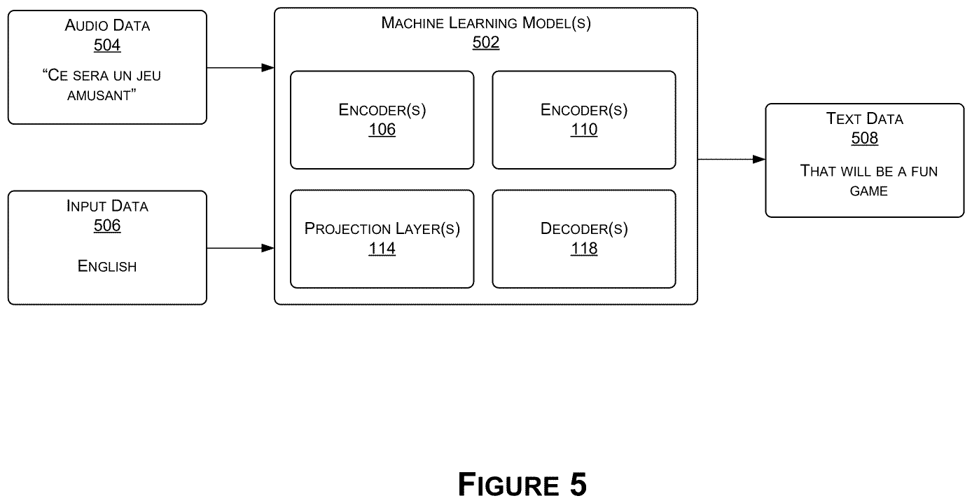

For instance, FIG. 5 illustrates an example of using one or more machine learning models 502 to perform ASR processing and translation processing, in accordance with some embodiments of the present disclosure. As shown, the machine learning model(s) 502 may receive, as input, audio data 504 representing speech in the French language along with input data 506 representing a selection to translate the speech to the English language. As such, the machine learning model(s) 502 may perform one or more of the processes described herein to generate text data 508 representing text corresponding to the speech and in the English language.

For instance, the machine learning model(s) 502 may use the encoder(s) 106 to process the audio data 504 and generate one or more audio representations associated with the audio data 504. The machine learning model(s) 502 may also use the encoder(s) 110 to process the input data 506 and generate one or more language representations associated with the target language of English. Additionally, the machine learning model(s) 502 may use the projection layer(s) 114 to process the audio representation(s) and the language representation(s) to generate one or more combined representations. The machine learning model(s) 502 may then use the decoder(s) 118 to process the combined representation(s) to generate the text data 508 representing the text corresponding to the speech and in English.

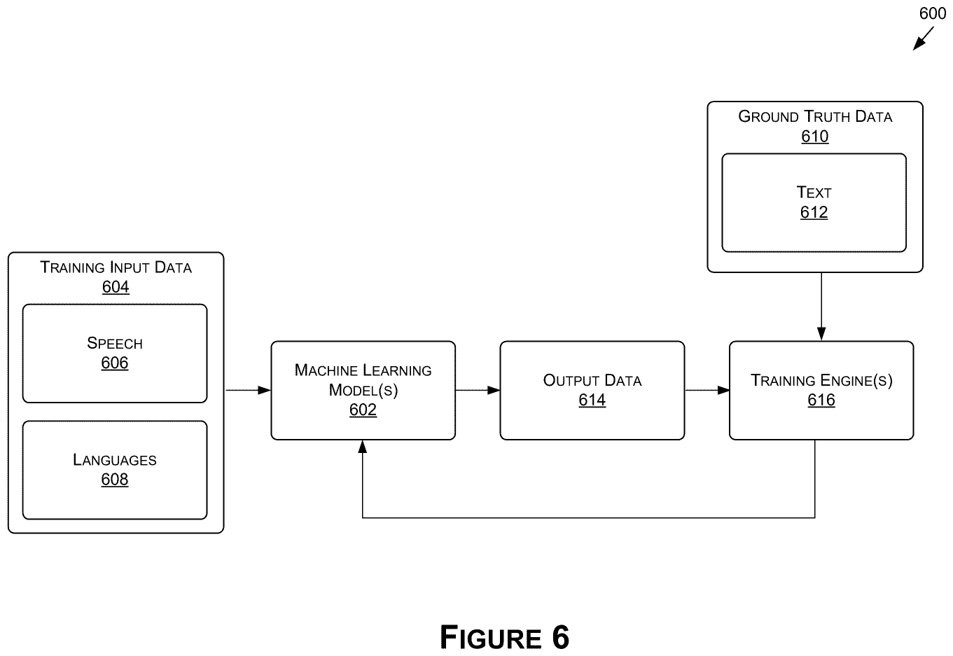

As described herein, the machine learning model(s) 502 may be trained to perform one or more of the processes described herein of performing ASR processing and translation processing. For instance, FIG. 6 illustrates an example of a process for training one or more machine learning models 602 (which may include, and/or be similar to, the machine learning model(s) 502) to perform ASR processing and translation processing, in accordance with some embodiments of the present disclosure.

As shown, the machine learning model(s) 602 may be trained using training input data 604. In some examples, the training input data 604 may include audio data representing instances of speech 606. For example, an instance of speech may include “Can you tell me where to find the character,” “That will be fun to perform,” “Please provide me with directions,” and/or any other speech. The training input data 604 may further represent a manifest of languages 608 associated with translating the instances of speech 606. For instance, in some examples, an instance of speech 606 may be associated with a corresponding language 608 for performing the translation. In some examples, the training input data 604 may be real produced, synthetically produced, and/or any combination thereof.

The machine learning model(s) 602 may be trained using the training input data 604 along with corresponding ground truth data 610. As shown, in some examples, the ground truth data 610 may include at least text corresponding to the instances of speech 606 translated in the languages 608. In some examples, for each instance of the training input data 604—such as each instance of speech 606 with the corresponding language 608—there may be corresponding ground truth data 610 that represents the desired text 612. In some examples, the ground truth data 610 may be real produced, synthetically produced, human labeled, machine labeled, and/or any combination thereof.

As shown, the process 600 may include the machine learning model(s) 602 processing the training input data 604 to generate output data 614 corresponding to the training input data 604. For instance, the output data 614 may represent estimated text corresponding to the instances of speech 606 translated into the languages 608. The process 600 may then include one or more training engines 616 using one or more loss functions that measure loss (e.g., error) in the output data 614 as compared to the ground truth data 610. For instance, in some examples, the loss function(s) may measure the loss based at least on differences between the estimated text represented by the output data 614 and the text 612 represented by the ground truth data 610. The training engine(s) 616 may then perform backward pass computations to recursively compute gradients of the loss function(s) with respect to training parameters in order to update the parameters and/or weights of the machine learning model(s) 602, which is indicated by the arrow from the training engine(s) 616 to the machine learning model(s) 602. For example, the training engine(s) 616 may update the parameters and/or weights of the encoder(s), the projection layer(s), and/or the decoder(s) of the machine learning model(s) 602.

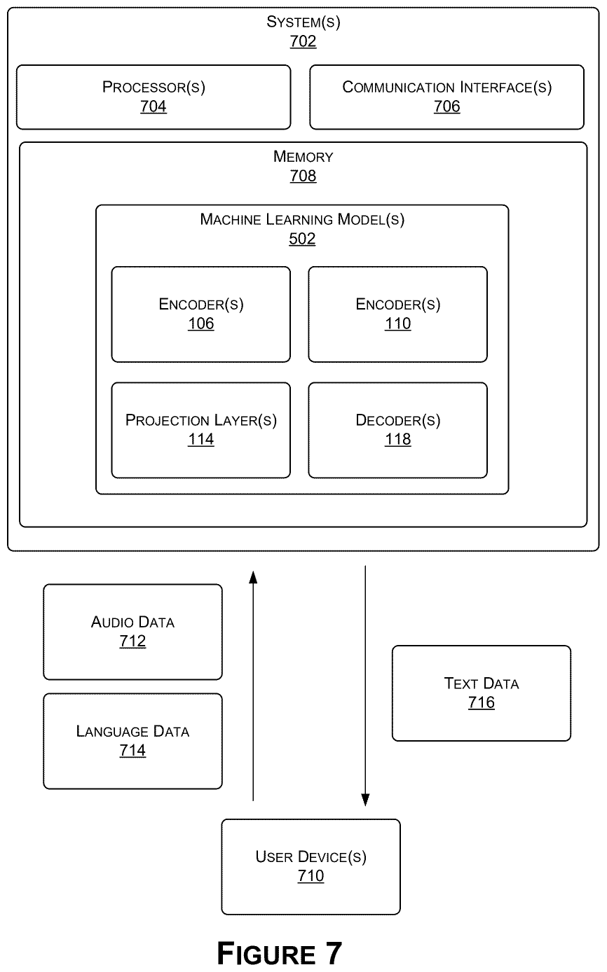

FIG. 7 illustrates an example of one or more systems 702 that may perform one or more of the processes described herein to translate speech, in accordance with some embodiments of the present disclosure. As shown, the system(s) 702 may include one or more processors 704 (which may include, and/or be similar to, a CPU(s) 1106 and/or a GPU(s) 1108), one or more communication interfaces 706 (which may include, and/or be similar to, a communication interface(s) 1110), and a memory 708 (which may include, and/or be similar to, a memory 1104). Additionally, the memory 708 may store at least the machine learning model(s) 502 which may then be executed by the processor(s) 704 to perform one or more of the operations described herein.

For instance, and as shown, the system(s) 702 may receive, from one or more user devices 710, audio data 712 (which may include, and/or be similar to, audio data 102) representing speech from users along with language data 714 (which may include, and/or be similar to, language data 104) representing target languages that the users would like the speech translated. The system(s) 702 may then perform one or more of the processes described herein to process the audio data 712 and the language data 714 using the machine learning model(s) 502 to generate text data 716 (which may include, and/or be similar to, text data 120) representing text corresponding to the speech and in the target languages. Additionally, the system(s) 702 may send the text data 716 back to the user device(s) 710 such that the user device(s) 710 may provide the text to the users.

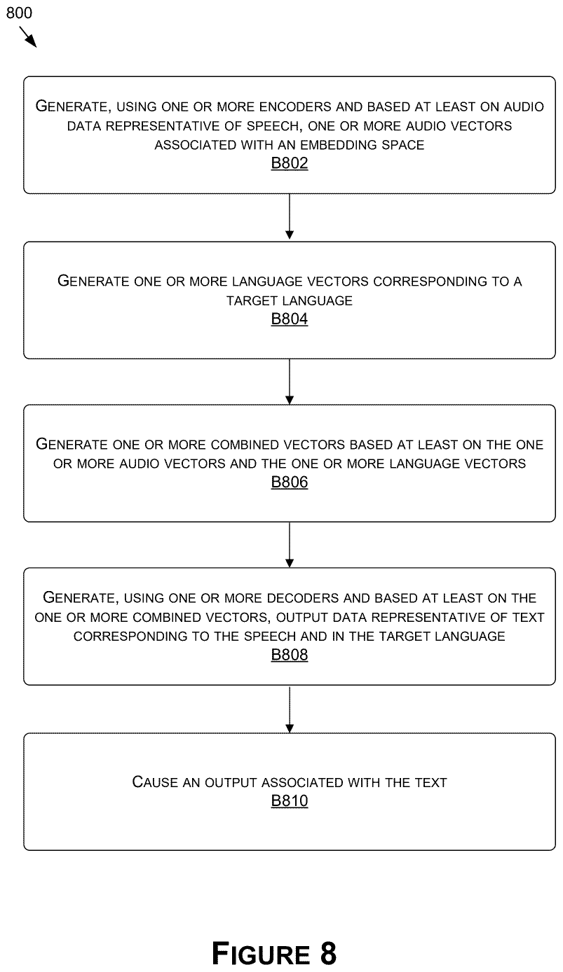

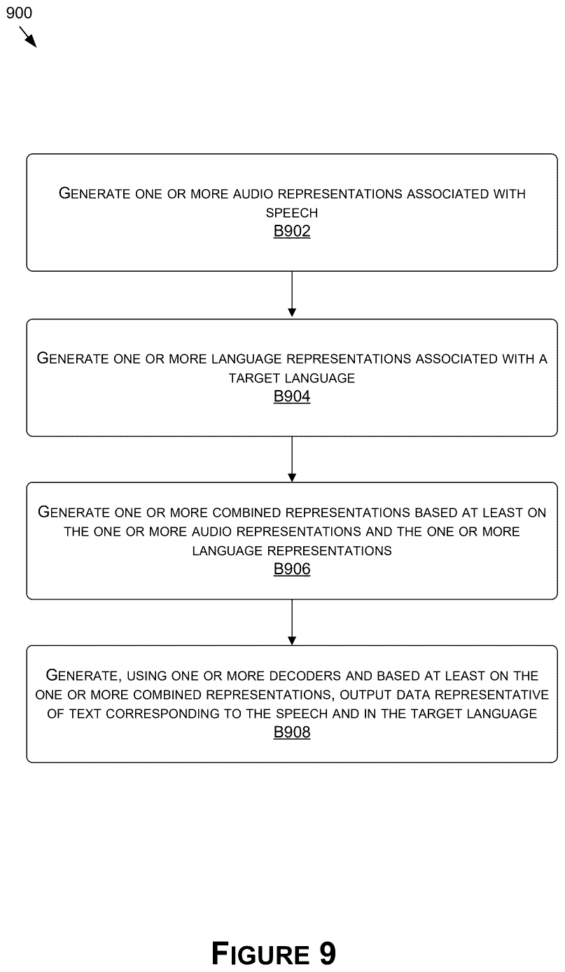

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, these methods 800 and 900 described, by way of example, with respect to FIG. 1. However, these methods 800 and 900 may additionally or alternatively be executed by any one system, or any combination of systems, including, but not limited to, those described herein.

FIG. 8 illustrates a flow diagram showing a method 800 for using a multilingual model to translate speech into text, in accordance with some embodiments of the present disclosure. The method 800, at block B802, may include generating, using one or more encoders based at least on audio data representative of speech, one or more audio vectors associated with an embedding space. For instance, the encoder(s) 106 may process the audio data 102 representing the speech to generate the audio vector(s) associated with the embedding space, where the audio vector(s) may be represented by the audio representation(s) 108.

The method 800, at block B804, may include generating one or more language vectors corresponding to a target language. For instance, the encoder(s) 110 may process the language data 104 representing the target language to generate the language vector(s) corresponding to the target language, where the language vector(s) may be represented by the language representation(s) 112. As described herein, in some examples, the language vector(s) may include dimensions associated with a number of target languages that may be used when performing speech translation. In such examples, the language vector(s) may include a first value for one or more elements associated with the target language and a second value for one or more other elements associated with one or more other languages.

The method 800, at block B806, may include generating one or more combined vectors based at least on the one or more audio vectors and the one or more language vectors. For instance, the projection layer(s) 114 may process the audio vector(s) and the language vector(s) to generate the combined vector(s), where the combined vector(s) may be represented by the combined representation(s) 116. As described herein, in some examples, the projection layer(s) 114 may generate the combined vector(s) by concatenating the audio vector(s) with the language vector(s) and/or projecting the concatenated vector(s) back to a dimensionality associated with the audio vector(s). In some examples, the projection layer(s) 114 may generate the combined vector(s) by multiplying the language vector(s) by a matrix associated with frequencies and then adding that result to the audio vector(s).

The method 800, at block B808, may include generating, using one or more decoders and based at least on the one or more combined vectors, output data representative of text corresponding to the speech and in the target language. For instance, the decoder(s) 118 may process the combined vector(s) to generate the text data 120 representing the text corresponding to the speech and in the target language. As described herein, in some examples, the text data 120 may represent a final text version of the speech, such as transcribed text corresponding to the speech. However, in other examples, the text data 120 may represent a tokenized version of the speech. In such examples, one or more other processing components may process the text data 120 to generate the final text version of the speech.

The method 800, at block B810, may include causing an output associated with the text. For instance, the text may be displayed to one or more users, the text data 120 may be sent to one or more user devices that then output the text, audio data representing the text may be used to output speech associated with the text, processing the text using one or more additional processing components, and/or any other type of output may be provided.

FIG. 9 illustrates a flow diagram showing a method 900 for translating speech to text that is in a target language, in accordance with some embodiments of the present disclosure. The method 900, at block B902, may include generating one or more audio representations associated with speech. For instance, the encoder(s) 106 may process the audio data representing the speech to generate the audio representation(s) 108. As described herein, an audio representation 108 may include, but is not limited to, one or more vectors, one or more embeddings, one or more tensors, one or more kernels, one or more features, and/or any other type of representation of the audio data.

The method 900, at block B904, may include generating one or more language representations associated with a target language. For instance, the encoder(s) 110 may process the language data 104 representing the target language to generate the language representation(s) 112 associated with the target language. As described herein, a language representation 112 may include, but is not limited to, one or more vectors, one or more embeddings, one or more tensors, one or more kernels, one or more features, and/or any other type of representation. Additionally, the language representation(s) 112 may include one or more first values for one or more elements associated with the target language and one or more second values for one or more other elements associated with one or more other languages.

The method 900, at block B906, may include generating one or more combined representations based at least on the one or more audio representations and the one or more language representations. For instance, the projection layer(s) 114 may generate the combined representation(s) 116 using the audio representation(s) 108 and the language representation(s) 112. As described herein, in some examples, the projection layer(s) 114 may generate the combined representation(s) 116 by concatenating the audio representation(s) 108 with the language representation(s) 112 and/or projecting the concatenated representation(s) back to a dimensionality associated with the audio representation(s) 108. In some examples, the projection layer(s) 114 may generate the combined representation(s) 116 by multiplying the language representation(s) 112 by a matrix associated with frequencies and then adding that result to the audio representation(s) 108.

The method 900, at block B908, may include generating, using one or more decoders and based at least on the one or more combined representations, output data representative of text corresponding to the speech and in the target language. For instance, the decoder(s) 118 may process the combined representation(s) 116 to generate the text data 120 representing the text corresponding to the speech and in the target language. As described herein, in some examples, the text data 120 may represent a final text version of the speech, such as transcribed text corresponding to the speech. However, in other examples, the text data 120 may represent a tokenized version of the speech. In such examples, one or more other processing components may process the text data 120 to generate the final text version of the speech.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

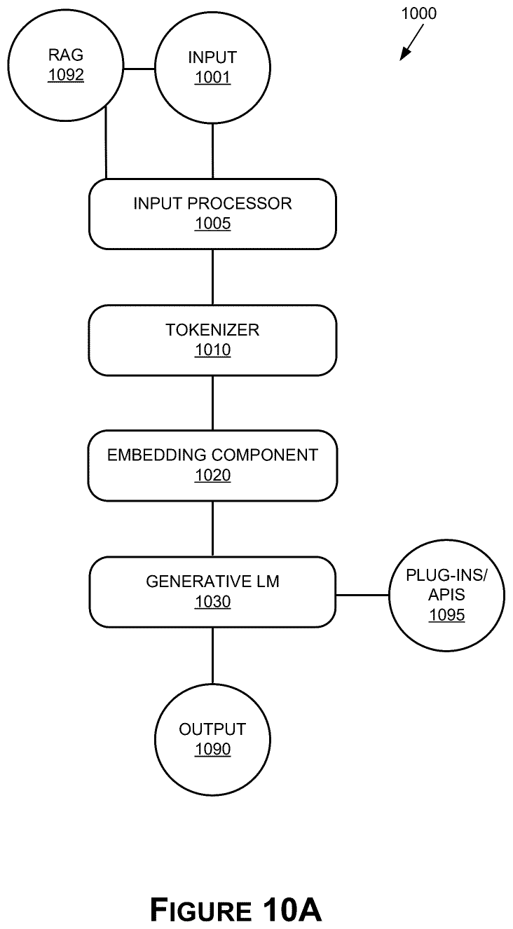

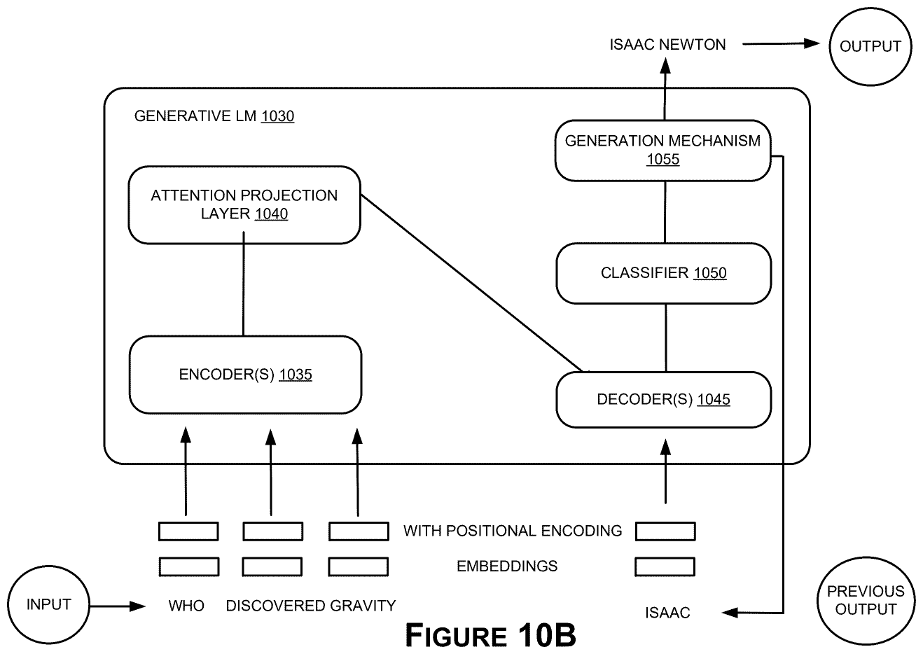

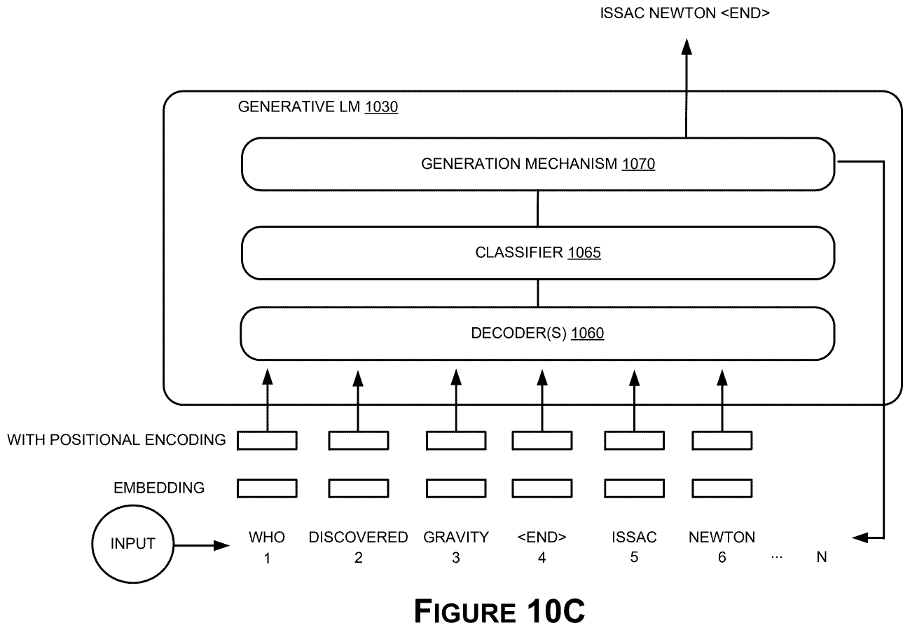

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™(hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, using one or more first encoders of one or more machine learning models and based at least on audio data representative of speech, one or more audio vectors associated with an embedding space; generating, using the one or more machine learning models, one or more language vectors corresponding to a target language; generating one or more combined vectors based at least on the one or more audio vectors and the one or more language vectors; generating, using one or more decoders of the one or more machine learning models and based at least on the one or more combined vectors, output data representative of text corresponding to the speech and in the target language; and causing an output associated with the text.

B: The method of paragraph A, wherein: a language vector of the one or more language vectors includes a number of elements that is associated with a number of target languages; a first element, from the number of elements, that is associated with the target language includes a first value; and one or more second elements, from the number of elements, that are associated with one or more other languages include a second value.

C: The method of either paragraph A or paragraph B, wherein the generating the one or more combined vectors comprises concatenating the one or more audio vectors with the one or more language vectors.

D: The method of any one of paragraphs A-C, further comprising: generating, based at least on processing the one or more combined vectors using one or more projection layers of the one or more machine learning models, one or more fused features, wherein the generating the output data representative of the text uses the one or more decoders and is based at least on the one or more fused features.

E: The method of any one of paragraphs A-D, further comprising: generating one or more second language vectors based at least on the one or more language vectors and a matrix representative of one or more frequencies associated with the target language, wherein the generating the one or more combined vectors is based at least on the one or more audio vectors and the one or more second language vectors.

F: The method of paragraph E, wherein the generating the one or more combined vectors is based at least on masking the one or more audio vectors using the one or more second language vectors.

G: The method of any one of paragraphs A-F, further comprising: receiving, from a user device, the audio data and input data representative of the target language, wherein the generating the one or more language vectors is based at least on the input data.

H: The method of any one of paragraphs A-G, wherein: the output data represents one or more tokens corresponding to the text; and the method further comprising generating, using the one or more machine learning models and based at least on the one or more tokens, the text corresponding to the speech and in the target language.

I: A system comprising: one or more processors to: generate, based at least on audio data representative of speech, one or more audio representations associated with an embedding space; generate one or more language representations corresponding to a target language; generate one or more combined representations using the one or more audio representations and the one or more target representations; and generate, using one or more machine learning models and based at least on the one or more combined representations, output data representative of text corresponding to the speech and in the target language.

J: The system of paragraph I, wherein: a language representation of the one or more language representations includes a number of elements that is associated with a number of target languages; a first element, from the number of elements, that is associated with the target language includes a first value; and one or more second elements, from the number of elements, that are associated with one or more other languages include a second value.

K: The system of either paragraph I or paragraph J, where the one or more combined representations are generated based at least on concatenating the one or more audio representations with the one or more language representations.

L: The system of any one of paragraphs I-K, wherein the one or more processors are further to: generate, based at least on processing the one or more combined representations using one or more projection layers, one or more fused features, wherein the output data representative of the text is generated using the one or more machine learning models and based at least on the one or more fused features.

M: The system of any one of paragraphs I-L wherein the one or more processors are further to: generate one or more second language representations based at least on the one or more language representations and a matrix that represents one or more frequencies associated with the target language, wherein the one or more combined representations are generated based at least on the one or more audio representations and the one or more second language representations.

N: The system of any one of paragraphs I-M, wherein the one or more processors are further to: receive, from s user device, the audio data and input data representative of the target language, wherein the one or more language representations are generated based at least on the input data; and send, to the user device, the output data representative of the text.

O: The system of any one of paragraphs I-N, wherein: the output data represents one or more tokens corresponding to the text; and the one or more processors are further to generate, using the one or more machine learning models and based at least on the one or more tokens, the text corresponding to the speech and in the target language.

P: The system of any one of paragraphs I-O, wherein the one or more processors are further to: generate, based at least on the audio data, one or more second audio representations associated with the embedding space; generate one or more second language representations corresponding to a second target language; generate one or more second combined representations using the one or more second audio representations and the one or more second target representations; and generate, using the one or more machine learning models and based at least on the one or more second combined representations, second output data representative of second text corresponding to the speech and in the second target language.

Q: The system of any one of paragraphs I-P, wherein: the one or more audio representations include one or more audio vectors associated with one or more timestamps corresponding to the audio data; and the one or more language representations include one or more language vectors associated with the one or more timestamps.

R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: One or more processors comprising: processing circuitry to: generate, using a machine learning model and based at least on concatenating one or more audio vectors associated with speech with one or more language vectors associated with a target language, output data representative of text corresponding to the speech and in the target language; and cause an output associated with the speech and in the target language.

T: The one or more processors of paragraphs S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
generating, using one or more first encoders of one or more machine learning models and based at least on audio data representative of speech, one or more audio vectors associated with an embedding space;
generating, using the one or more machine learning models, one or more language vectors corresponding to a target language;
generating one or more combined vectors based at least on the one or more audio vectors and the one or more language vectors;
generating, using one or more decoders of the one or more machine learning models and based at least on the one or more combined vectors, output data representative of text corresponding to the speech and in the target language; and
causing an output associated with the text.

2. The method of claim 1, wherein:
a language vector of the one or more language vectors includes a number of elements that is associated with a number of target languages;
a first element, from the number of elements, that is associated with the target language includes a first value; and
one or more second elements, from the number of elements, that are associated with one or more other languages include a second value.

3. The method of claim 1, wherein the generating the one or more combined vectors comprises concatenating the one or more audio vectors with the one or more language vectors.

4. The method of claim 1, further comprising:
generating, based at least on processing the one or more combined vectors using one or more projection layers of the one or more machine learning models, one or more fused features,
wherein the generating the output data representative of the text uses the one or more decoders and is based at least on the one or more fused features.

5. The method of claim 1, further comprising:
generating one or more second language vectors based at least on the one or more language vectors and a matrix representative of one or more frequencies associated with the target language,
wherein the generating the one or more combined vectors is based at least on the one or more audio vectors and the one or more second language vectors.

6. The method of claim 5, wherein the generating the one or more combined vectors is based at least on masking the one or more audio vectors using the one or more second language vectors.

7. The method of claim 1, further comprising:
receiving, from a user device, at least one of the audio data or input data representative of the target language,
wherein the generating the one or more language vectors is based at least on the at least one of the audio data or the input data.

8. The method of claim 1, wherein:
the output data represents one or more tokens corresponding to the text; and
the method further comprising generating, using the one or more machine learning models and based at least on the one or more tokens, the text corresponding to the speech and in the target language.

9. A system comprising:
one or more processors to:
generate, based at least on audio data representative of speech, one or more audio representations associated with an embedding space;
generate one or more language representations corresponding to a target language;
generate one or more combined representations using the one or more audio representations and the one or more target representations; and
generate, using one or more machine learning models and based at least on the one or more combined representations, output data representative of text corresponding to the speech and in the target language.

10. The system of claim 9, wherein:
a language representation of the one or more language representations includes a number of elements that is associated with a number of target languages;
a first element, from the number of elements, that is associated with the target language includes a first value; and
one or more second elements, from the number of elements, that are associated with one or more other languages include a second value.

11. The system of claim 9, where the one or more combined representations are generated based at least on concatenating the one or more audio representations with the one or more language representations.

12. The system of claim 9, wherein the one or more processors are further to:
generate, based at least on processing the one or more combined representations using one or more projection layers, one or more fused features,
wherein the output data representative of the text is generated using the one or more machine learning models and based at least on the one or more fused features.

13. The system of claim 9, wherein the one or more processors are further to:
generate one or more second language representations based at least on the one or more language representations and a matrix that represents one or more frequencies associated with the target language,
wherein the one or more combined representations are generated based at least on the one or more audio representations and the one or more second language representations.

14. The system of claim 9, wherein the one or more processors are further to:
receive, from s user device, the audio data and input data representative of the target language, wherein the one or more language representations are generated based at least on the input data; and
send, to the user device, the output data representative of the text.

15. The system of claim 9, wherein:
the output data represents one or more tokens corresponding to the text; and
the one or more processors are further to generate, using the one or more machine learning models and based at least on the one or more tokens, the text corresponding to the speech and in the target language.

16. The system of claim 9, wherein the one or more processors are further to:
generate, based at least on the audio data, one or more second audio representations associated with the embedding space;
generate one or more second language representations corresponding to a second target language;
generate one or more second combined representations using the one or more second audio representations and the one or more second target representations; and
generate, using the one or more machine learning models and based at least on the one or more second combined representations, second output data representative of second text corresponding to the speech and in the second target language.

17. The system of claim 9, wherein:
the one or more audio representations include one or more audio vectors associated with one or more timestamps corresponding to the audio data; and
the one or more language representations include one or more language vectors associated with the one or more timestamps.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
generate, using a machine learning model and based at least on concatenating one or more audio vectors associated with speech with one or more language vectors associated with a target language, output data representative of text corresponding to the speech and in the target language; and
cause an output associated with the speech and in the target language.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
